(19) United States
(12) Patent Application Publication
(10) Pub. No.: US 2021/0032736 A1
(43) Pub. Date: Feb. 4, 2021

(54) METHOD OF CHEMICAL DEPOSITION OF IRIDIUM OXIDE FILM ON RIGID SUBSTRATE

(71) Applicant: NATIONAL CHIAO TUNG UNIVERSITY, HSINCHU CITY (TW)

(72) Inventors: PU-WEI WU, ZHUBEI CITY (TW); CHUNG-YU WU, HSINCHU CITY (TW); KUANG-CHIH TSO, KAOHSIUNG CITY (TW); YI-CHIEH HSIEH, KAOHSIUNG CITY (TW); HAN-YI WANG, TAICHUNG CITY (TW)

(21) Appl. No.: 16/526,156

(22) Filed: Jul. 30, 2019

(51) Int. Cl. C23C 2/04; C23C 2/00

(52) U.S. Cl. CPC C23C 2/04; C23C 2/003

(57) ABSTRACT

A method of chemical deposition of Iridium oxide film on rigid substrate is provided. The method comprises providing a rigid substrate in a container, adding an iridium precursor and mixing the iridium precursor with water to form an iridium precursor liquid in the container, adding and mixing an oxidant with the iridium precursor liquid in the container; and depositing an iridium oxide film on the rigid substrate in the container. A chelating agent and pH adjustor can be either selectively used for stabilizing the chemical bath deposition and for adjusting pH value of the liquid. For a variety of rigid substrates to be applied, the pH adjustor can adjust the pH value within a range of 4˜13. By employing the proposed fabrication method, it is extraordinarily advantageous of chemical alkaline as well as chemical acid deposition formula with configuration of depositing sodium-doped IrOₓ iridium oxide film.

### BACKGROUND OF THE INVENTION

### Field of the Invention

The present invention relates to a chemical fabrication method, and more particularly to a certain kind of method of chemical deposition of iridium oxide film on a rigid substrate.

### Description of the Prior Art

The synthesis of iridium oxides has been receiving considerable attention since iridium oxide is characterized by enormously unique properties that make it an ideal material for applications in electro-chromism, bio-sensing and water electrolysis. Generally, the currently known fabrication methods for forming iridium oxide nowadays mainly comprise a following of: a sputtering method, a solution-gel method, and an electroplating method, and so on.

Regarding the sputtering method, it is generally operated in a vacuum system in which a high voltage electric field is mostly applied to make the argon gas form an argon ion stream. Next, the argon ion stream is then blown onto the cathode target to be sputtered and thus form a thin film on the substrate. In such a sputtering process, the high voltage of the electric field must be up to about 400 volts, and the argon gas pressure needs to be controlled to be 15.5 millitorr so that a flow rate of the argon ion stream can be controlled to be about 12.5 cubic centimeters per minute, and the desired iridium oxide film can be obtained in five minutes. Nevertheless, it should be noticed that the sputtering process has evitable disadvantages, such as the very highly expensive equipment, and the noble target is also high priced and vulnerable.

As for the solution-gel method, a variety of raw materials are uniformly mixed in a liquid phase at first. After the hydrolysis and condensation reactions occur, the original liquid solution starts to form a sol-gel, and after the sol-gel is slowly polymerized, it becomes a gel state which is not allowed to move freely. Compared to the foregoing sputtering method, the reaction process performing in the solution-gel method is able to be carried out at a lower temperature. However, costs of its raw materials are still too high to afford and the whole synthesis process always takes too much time, thus being a waste of both time and money.

In another aspect, the electroplating method is normally known as a most commonly used method in electrochemistry since it mainly employs an electrochemical phenomenon of anode performing oxidization and cathode performing reduction under electricity energization. Generally, there are two ways to plate the iridium oxide substrate. In one way, a substrate is directly connected to the cathode, so the iridium oxide is reducted and can be deposited on the substrate. The other way is to place the sputtered iridium film substrate on the anode and to use cyclic voltammetry to reduct it back to iridium oxide. Among these two electroplating methods, the iridium oxide thin film deposited on the substrate can be obtained. However, it should be noticed that there are still existing disadvantages of the electroplating method, comprising the following shortcomings that are: the substrates being used are limited and must be made of conductive materials. Besides, the plating solution is very likely prone to spontaneously generating redox reactions such that the plating solution would be damaged.

Therefore, on account of above, to overcome the abovementioned problems, it should be obvious that there is indeed an urgent need for the professionals in the field for a novel iridium oxide fabrication method to be developed that can effectively solve those above mentioned problems occurring in the prior design.

### SUMMARY OF THE INVENTION

In order to overcome the above mentioned disadvantages, an approach in accordance with the present invention is provided for a method of chemical deposition of iridium oxide film on a rigid substrate.

In the present invention, a formulation for chemical deposition of iridium oxide film (IrO₂) on a rigid substrate is demonstrated, in which a chemical bath deposition route is employed with the Ir precursor, oxidants, and/or alternatively disposed chelating agent as well as pH adjustor. The reaction steps responsible for IrO₂ formation are explored and acknowledged in the present invention.

According to the present invention, a proposed method of chemical deposition of iridium oxide film on rigid substrate, comprising the following steps of: providing a rigid substrate in a container, adding an iridium precursor and mixing the iridium precursor with water to form an iridium precursor liquid in the container, adding and mixing an oxidant with the iridium precursor liquid in the container, and depositing an iridium oxide film on the rigid substrate in the container.

In one embodiment of the present invention, the iridium precursor can be selected from a group consisting of Na₃IrCl₆, K₃IrCl₆, IrCl₃, IrBr₃, Na₂IrCl₆, K₂IrCl₆, and (NH₄)₂IrCl₆. Alternatively, the iridium precursor can be selected as a mixture of all the above mentioned iridium precursor including Na₃IrCl₆, K₃IrCl₆, IrCl₃, IrBr₃, Na₂IrCl₆, K₂IrCl₆, and (NH₄)₂IrCl₆ as well. The oxidant can be selected from a group consisting of NaClO, NaClO₂, KClO, NaBrO₃, Ca(ClO)₂, and a mixture of NaClO, NaClO₂, KClO, NaBrO₃, Ca(ClO)₂ and H₂O₂. For a variety of rigid substrates to be deposited upon, the rigid substrate can be made of Ti, TiW, Al, Ni, Au, Pt, Ptlr, stainless steel or indium tin oxide (ITO). And, a reaction temperature of the proposed chemical deposition method is in a range of 0˜100° C.

To be more specific, in a preferred embodiment of the present invention, a concentration of the iridium precursor liquid is in a range of 0.01 mM˜1 M, and a concentration of the oxidant is in a range of 8 μM˜2 M. Alternatively, a chelating agent and a pH adjustor can be either selectively used for stabilizing the chemical bath deposition and for adjusting pH value of the liquid. For example, a chelating agent, such as Malonate, succinate, tartrate, citrate, oxalate, EDTA-2Na, or a mixture of the above mentioned chelating agents including Malonate, succinate, tartrate, citrate, oxalate and EDTA-2Na, can be optionally added in the iridium precursor liquid for preventing unexpected Iridium particles forming in the liquid. Moreover, NaOH, KOH, TABOH, or HNO₃, such pH adjustors can be optionally added as well for adjusting a pH value of the liquid in order to create an alkalinity or acidity condition of the liquid for the rigid substrate to be deposited upon. Under such arrangements, the pH value of the prepared liquid can be controlled within a range of 4˜13.

Furthermore, by properly selecting the ingredients of the above mentioned components for fabrication of the present invention, the iridium oxide film can be alternatively Na-doped, and a mole ratio of sodium (Na) to iridium (Ir) is in a range of 0˜4. That is, in another embodiment of the present invention, the proposed iridium oxide being fabricated can be sodium doped free as well, which is not intended to limit the scope of the present invention. For people skilled in the art having understandings and technical solutions to the present invention, various modifications and changes are allowed to be followed without departing from the scope of the invention and yet still fall into the invention scope of the present application.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a flow chart of a method of chemical deposition of iridium oxide film on rigid substrate in accordance with one embodiment of the present invention.

FIGS. 2A, 2B, 2C, and 2D show sequential fabrication illustrations according to a first embodiment of the present invention employing the method of chemical deposition of iridium oxide film on rigid substrate.

FIG. 2E shows an illustrative diagram of the product of iridium oxide film deposited on a rigid substrate according to a first embodiment of the present invention.

FIGS. 3A, 3B, and 3C show sequential fabrication illustrations according to a second embodiment of the present invention employing the method of chemical deposition of iridium oxide film on rigid substrate.

FIG. 3D shows an illustrative diagram of the product of iridium oxide film deposited on a rigid substrate according to a second embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

In order to overcome the conventional problems, the proposed solution of the present invention provides a method of chemical deposition of iridium oxide film on a rigid substrate, which adopts a chemical alkaline as well as chemical acid deposition formula for depositing sodium-doped IrOₓ iridium oxide film. With a variety of precursors being chosen, for example, K₃IrCl₆, IrCl₃, IrBr₃, or K₂IrCl₆, the iridium oxide film can be sodium-doped free as well. By employing the chemical deposition method of the present invention, the iridium oxide film can be selectively deposited on various rigid substrates to obtain an IrOₓ film with high uniformity. Moreover, owing to the excellent biocompatibility of the IrOₓ film, it is advantageous of being applied as stimulating electrodes for implantable future biomedical devices.

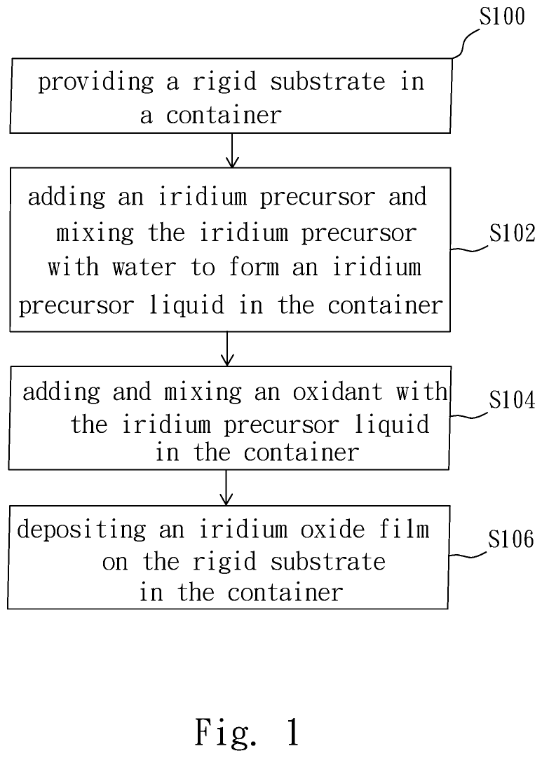

Please refer to FIG. 1, which shows a flow chart of a method of chemical deposition of iridium oxide film on rigid substrate in accordance with one embodiment of the present invention. The proposed method of the present invention comprising the following steps:

Step S100: providing a rigid substrate in a container.

Step S102: adding an iridium precursor and mixing the iridium precursor with water to form an iridium precursor liquid in the container.

Step S104: adding and mixing an oxidant with the iridium precursor liquid in the container; and

Step S106: depositing an iridium oxide (IrOₓ) film on the rigid substrate in the container.

Since what the present invention expected is to deposit uniform iridium oxide (IrOₓ) film on the rigid substrate, a chelating agent can be further added in the iridium precursor liquid for preventing unexpected iridium particles forming in the liquid according to a preferred embodiment of the present invention.

Moreover, according to the present invention, the rigid substrate where the expected iridium oxide (IrOₓ) film is grown upon can be selectively made of Ti, TiW, Al, Ni, Au, Pt, Ptlr, stainless steel or indium tin oxide (ITO). In addition, various types of substrates have different resistance to acidity and alkalinity. In order to make the liquid condition and/or environment suitable for the acidity and/or alkalinity tolerance of the substrate, a pH adjustor for adjusting a pH value of the liquid in the container might be necessary and can be further employed in the present invention depending on practical needs.

Please find Table 1, which shows a shortlist of a plurality of available formula for implementing the proposed method of chemical deposition of iridium oxide film on rigid substrate of the present invention.

TABLE 1

| | chelating | | | |
|---|---|---|---|---|
| precursor | agent | pH adjustor | oxidant | Final pH |
| Na₃IrCl₆ | Malonate | NaOH | NaClO | 12~13 |
| K₃IrCl₆ | succinate | KOH | NaClO₂ | 12~13 |
| IrCl₃ | tartrate | TABOH | KClO | 12~13 |
| IrBr₃ | citrate | HNO₃ | NaBrO₃ | 12~13 |
| Na₂IrCl₆ | oxalate | | NaClO + H₂O₂ | 4~9 |
| K₂IrCl₆ | EDTA-2Na | | Ca(ClO)₂ | 12~13 |
| (NH₄)₂IrCl₆ | w/o chelating | | | |
| | agent | | | |

As shown, the iridium precursor can be selected from a group consisting of Na₃IrCl₆, K₃IrCl₆, IrCl₃, IrBr₃, Na₂IrCl₆, K₂IrCl₆, and (NH₄)₂IrCl₆. Alternatively, the iridium precursor the present invention uses can be also selected as a mixture of all the above mentioned iridium precursor including Na₃IrCl₆, K₃IrCl₆, IrCl₃, IrBr₃, Na₂IrCl₆, K₂IrCl₆, and (NH₄)₂IrCl₆.

According to a preferred embodiment of the present invention, the chelating agent can be chosen as Malonate, succinate, tartrate, citrate, oxalate, or EDTA-2Na. Alternatively, according to other embodiment of the present invention, the chelating agent being employed by the proposed invention can be also selected as a mixture of all the above mentioned chelating agents including Malonate, succinate, tartrate, citrate, oxalate, and EDTA-2Na. People skilled in the art are allowed to make or create equivalent modification or variation according to the spirits of the present invention, whereby is still to be also included within the scope of the proposed invention.

The pH adjustor can be either NaOH, KOH, TABOH, or HNO₃.

Nevertheless, it should be noticed that the formula of the present invention can be prepared with or without these chelating agent and/or pH adjustor, depending on pH concentration of the liquid, acidity and/or alkalinity tolerance of the substrate, deposition stability of the IrOₓ film and so on. In other words, the chelating agent and/or the pH adjustor listed as above are mainly optional, and can be selectively disposed according to a variety of needs, specifications, liquid conditions, and so on.

Regarding the choice of oxidant being used in the present invention, the oxidant can be selected from a group consisting of NaClO, NaClO₂, KClO, NaBrO₃, Ca(ClO)₂, and a mixture of NaClO, NaClO₂, KClO, NaBrO₃, Ca(ClO)₂ and H₂O₂. It is important to observe that a final pH value of the liquid in the formula is more likely in a range of 12˜13, showing alkalinity. However, when the oxidant is a mixture of NaClO and H₂O₂, the final pH of the liquid solution can be decreased to be in a range of 4˜13, possibly showing acidity. Under such circumstances, substrates having poor tolerance with alkalinity while better tolerance with acidity can be employed and prepared according to such embodiment of the present invention, by which the proposed method of chemical deposition of iridium oxide film on rigid substrate of the present invention can be extensively applied, especially for iridium oxide (IrOₓ) film to be grown on the rigid substrate which is mostly acid resistant

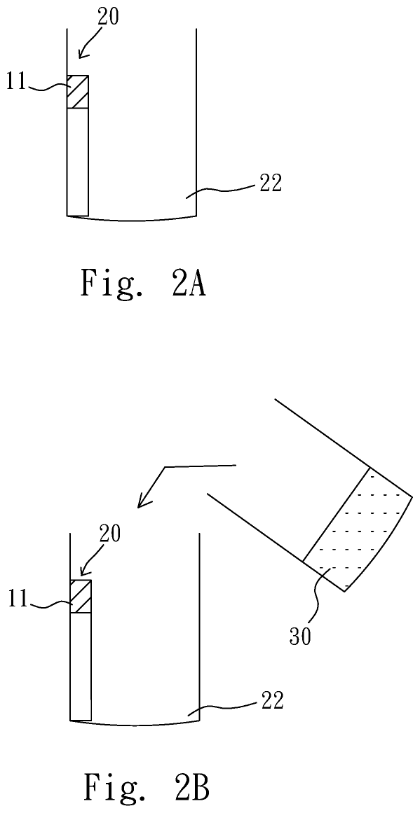

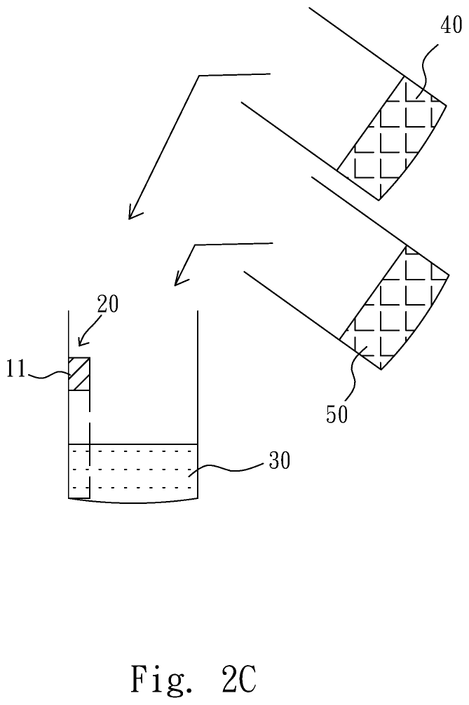

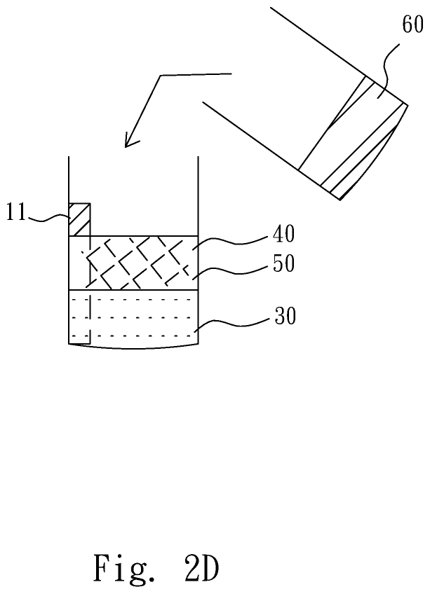

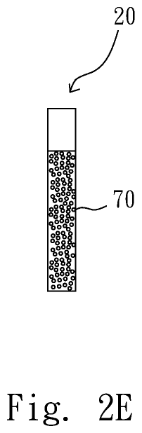

Furthermore, please refer to FIGS. 2A, 2B, 2C, and 2D which show sequential fabrication illustrations according to a first embodiment of the present invention employing the method of chemical deposition of iridium oxide film on rigid substrate. FIG. 2E shows an illustrative diagram of the product of iridium oxide film deposited on a rigid substrate according to such a first embodiment of the present invention.

In the first embodiment shown in FIG. 2A, at first, a rigid substrate 20 is provided and fixed with tape 11 as vertically in a glass container 22. It is important to emphasize hereinafter that according to the present invention, the rigid substrate 20 we use could be placed in any steps, and the order is not aimed to limit the scope of the present invention. What we disclosed merely helps to illustrate one exemplary embodiment of the present invention. As such, the proposed invention is not limited thereto.

An iridium precursor liquid 30, such as potassium hexachloroiridate (III), K₃IrCl₆, is prepared (as described in step S102 in FIG. 1) and added into the container 22 as shown FIG. 2B. Later on, a chelating agent (0.01-0.5 M tartrate) 40 and a pH adjustor (0.1-1 M sodium hydroxide, NaOH) 50 are sequentially added and mixed up with the iridium precursor liquid 30 in FIG. 2C. In one embodiment, the chelating agent 40 can be added before the pH adjustor 50. Alternatively, the pH adjustor 50 can be added before the chelating agent 40. It draws our attention that the orders of these ingredients to be put and mixed up are not intended to limit the scope of the present invention but merely to show an exemplary embodiment of the present invention. For people skilled in the art having understandings and technical solutions to the present invention, various modifications and changes are allowed to be followed without departing from the scope of the invention and yet still fall into the invention scope of the present application.

Later in FIG. 2D, an oxidant 60, such as sodium hypochlorite, NaClO, is added so that the chemical bath and electro-less deposition occurs. In FIG. 2E, when the chemical bath deposition (CBD) reaction which usually takes 15 minutes, or even up to 72 hours is complete, the CBD-IrO₂ film 70 is successfully deposited on the rigid substrate 20, having its uniform film thickness approximately 40-80 nm.

According to the embodiment of the present invention, since the proposed chemical bath deposition (CBD) reaction is most likely taking place in an environment of 1 atmosphere (atm), such reaction temperature of the proposed fabrication method will be in a range of 0-100° C. However, while the chemical bath deposition (CBD) reaction is taking place under a variety of atmospheric pressure range, then the reaction temperature varies accordingly as well.

A concentration of the iridium precursor liquid is in a range of 0.01 mM-1 M, and a concentration of the oxidant is in a range of 8 μM˜2 M. By properly controlling the deposition rate of our iridium oxide film in a range of 0.3-1.76 nm/min, the IrOₓ film thickness is adjustable and estimable depending on the chemical bath deposition reaction time.

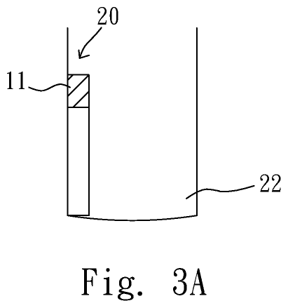

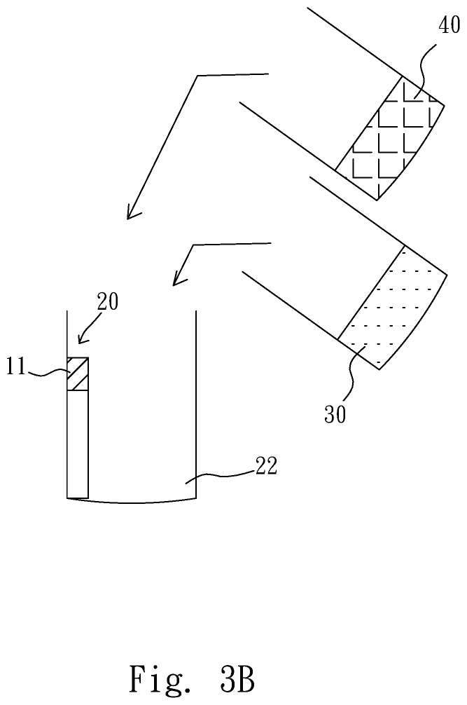

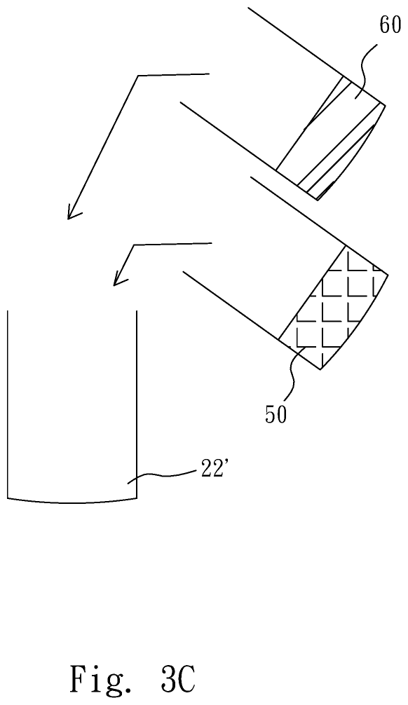

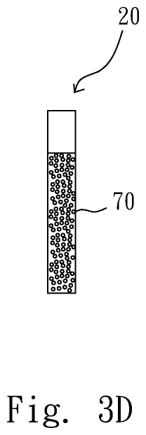

In another aspect, please find FIGS. 3A, 3B, and 3C, which show sequential fabrication illustrations according to a second embodiment of the present invention employing the method of chemical deposition of iridium oxide film on rigid substrate. FIG. 3D shows an illustrative diagram of the product of iridium oxide film deposited on a rigid substrate according to such a second embodiment of the present invention.

At first, a rigid substrate 20 is provided and fixed with tape 11 as vertically in a glass container 22 as shown in FIG. 3A. What differs from the first embodiment as mentioned earlier is that, the iridium precursor liquid 30 and the chelating agent 40 can be mixed in the container 22 as shown in FIG. 3B, and the pH adjustor 50 and the oxidant 60 can be mixed in another container 22′ as shown in FIG. 3C. Next, the container 22 as shown in FIG. 3B comprising the rigid substrate 20, the iridium precursor liquid 30 and the chelating agent 40 and the container 22′ as shown in FIG. 3C comprising the pH adjustor 50 and the oxidant 60 are mixed together. As such, in FIG. 3D when the chemical bath deposition reaction is complete, the CBD-IrO₂ film 70 is successfully deposited on the rigid substrate 20.

In view of all, from these two various embodiments, it is apparent that the formula in which these orders of ingredients are put together does not intend to limit the scope of the present invention. The proposed method of chemical deposition of iridium oxide film on rigid substrate employed by the present invention mainly comprises at least following steps of providing an iridium precursor liquid in the container, and mixing an oxidant with the iridium precursor liquid in the container so as to achieve the purpose of depositing an iridium oxide (IrOₓ) film on the rigid substrate as claimed. Therefore, it is believed that for those who are skilled in the art, various modifications and variations can be made to the present invention without departing from the scope or spirit of the invention while still fall into the scope of the invention and its equivalent.

Moreover, according to the present invention, the method of chemical deposition of iridium oxide film on rigid substrate mainly adopts a chemical bath deposition (also known as electro-less deposition). Since the whole formulation is involved with solution processes, and the content of the formula can optionally comprise sodium ions (Na⁺). Based on the contents, for example iridium precursors, oxidants, and/or pH adjustor, chelating agent being selected, the IrOₓ film product of the present invention may possibly contain sodium, and the concentration of the sodium content can be properly designed according to different formula solution adjustments. Overall, a mole ratio of sodium (Na) to iridium (Ir) can be set in a range of 0-4, so the iridium oxide film is alternatively Na-doped.

As a result, to sum up, a novel method of chemical deposition of iridium oxide film on rigid substrate has been provided in the present invention for configuration as well as implementations. By using such a chemical bath deposition method, the iridium oxide is able to deposit on a variety of desirable rigid substrates having different acidity and alkalinity tolerance. Since the iridium oxide (IrOₓ) film is well characterized by its chemical stability, biocompatibility, and high charge storage capacity (up to 16.8 mC/cm²), it has been always a better choice as the material for various biomedical devices, such as bio-stimulation electrodes and carriers of the cells. Moreover, by further relevant annealing taken along with a plurality of processes subsequently, the thickness of the iridium oxide (IrOₓ) film can be increased, which will be beneficial to improve the cell growth for both the human-machine interface and orientated substrates.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of chemical deposition of iridium oxide film on rigid substrate, comprising:
providing a rigid substrate in a container;
adding an iridium precursor and mixing said iridium precursor with water to form an iridium precursor liquid in said container;
adding and mixing an oxidant with said iridium precursor liquid in said container; and
depositing an iridium oxide film on said rigid substrate in said container.

2. The method of chemical deposition of iridium oxide film on rigid substrate according to claim 1, wherein said iridium precursor is selected from a group consisting of Na₃IrCl₆, K₃IrCl₆, IrCl₃, IrBr₃, Na₂IrCl₆, K₂IrCl₆, and (NH₄)₂IrCl₆.

3. The method of chemical deposition of iridium oxide film on rigid substrate according to claim 1, wherein said oxidant is selected from a group consisting of NaClO, NaClO₂, KClO, NaBrO₃, Ca(ClO)₂, and a mixture of NaClO, NaClO₂, KClO, NaBrO₃, Ca(ClO)₂ and H₂O₂.

4. The method of chemical deposition of iridium oxide film on rigid substrate according to claim 1, wherein said rigid substrate is made of Ti, TiW, Al, Ni, Au, Pt, Ptlr, stainless steel or indium tin oxide (ITO).

5. The method of chemical deposition of iridium oxide film on rigid substrate according to claim 1, wherein a reaction temperature of said method when taking place in an environment of 1 atmosphere (atm) is in a range of 0-100° C.

6. The method of chemical deposition of iridium oxide film on rigid substrate according to claim 1, wherein a concentration of said iridium precursor liquid is in a range of 0.01 mM-1 M.

7. The method of chemical deposition of iridium oxide film on rigid substrate according to claim 1, wherein a concentration of said oxidant is in a range of 8 μM˜2 M.

8. The method of chemical deposition of iridium oxide film on rigid substrate according to claim 1, after step of forming said iridium precursor liquid in said container, further comprising:
adding a chelating agent in said iridium precursor liquid for preventing unexpected Iridium particles forming in said liquid.

9. The method of chemical deposition of iridium oxide film on rigid substrate according to claim 1, before step of depositing said iridium oxide film on said rigid substrate in said container, further comprising:
adding a pH adjustor for adjusting a pH value of said liquid.

10. The method of chemical deposition of iridium oxide film on rigid substrate according to claim 8, wherein said chelating agent is Malonate, succinate, tartrate, citrate, oxalate, EDTA-2Na or a mixture of Malonate, succinate, tartrate, citrate, oxalate, and EDTA-2Na.

11. The method of chemical deposition of iridium oxide film on rigid substrate according to claim 9, wherein said pH adjustor is NaOH, KOH, TABOH, or HNO₃.

12. The method of chemical deposition of iridium oxide film on rigid substrate according to claim 9, wherein said pH adjustor adjusts said pH value of said liquid within a range of 4˜13.

13. The method of chemical deposition of iridium oxide film on rigid substrate according to claim 1, wherein a deposition rate of said iridium oxide film is in a range of 0.3˜1.76 nm/min.

14. The method of chemical deposition of iridium oxide film on rigid substrate according to claim 1, wherein said iridium oxide film is alternatively Na-doped, and a mole ratio of sodium (Na) to iridium (Ir) is in a range of 0˜4.
